(19) United States
(12) Patent Application Publication
(10) Pub. No.: US 2008/0036918 A1
(43) Pub. Date: Feb. 14, 2008

(54) Audio Control System Applied for Television and Method Thereof

(76) Inventor: Chao-Wei Huang, Tapiei Hsien (TW)

Correspondence Address: LAW OFFICES OF LAI AND ASSOCIATES, P.C., 5800 RANCHESTER STE 200, HOUSTON, TX, 77036, US

(21) Appl. No.: 11/760,380

(22) Filed: Jun. 8, 2007

(30) Foreign Application Priority Data
Aug. 12, 2006 (TW) 095145989

(51) Int. Cl. H04N 5/60

(52) U.S. Cl. 348/738

(57) ABSTRACT

An audio control system applied for a television and a method thereof are disclosed. The system includes an analog audio signal input unit, an audio processor, a video processor, an HDMI interfacing unit and a determination unit. The analog audio signal input unit is used to receive an analog audio signal. The HDMI interfacing unit is used to receive an HDMI signal, and extract and output a digital audio signal and a digital video signal from the HDMI signal. The video processor electrically connected to the HDMI interfacing unit is used to process the digital video signal. The determination unit is used to detect the audio signal status of the HDMI interfacing unit, and control the audio processor to receive the digital audio signal or the analog audio signal based on a detection result.

### FIELD OF THE INVENTION

The present invention relates to an audio control system applied for television and a method thereof, and more particularly to an audio control system and a method thereof that switch an audio signal input of a television by detecting a high definition multimedia (HDMI) signal.

### BACKGROUND OF THE INVENTION

As the demand for the quality of a video display and an audio output becomes increasingly higher and the data volume of high quality video signals and audio signals becomes increasingly larger, high quality audio/video signal interface standards are introduced constantly. For example, D-type video graphics array (VGA) connectors, a digital visual interface (DVI) standard, and a high definition multimedia interface (HDMI) standard are developed and introduced to provide a better audio/video quality. The VGA interface standard is provided for transmitting analog video signals, the DVI standard is provided for transmitting digital video signals, and the HDMI standard is provided for transmitting digital video signals and digital audio signals. The signals of HDMI standard and DVI standard are compatible with each other, and thus there are DVI and HDMI adapters available in the market.

However, not all information products or electric appliances come with the foregoing three kinds of interfaces due to cost consideration and insufficient space of external artistic design. If a user wants to input a video signal from a computer with DVI only to a television with HDMI only, then the user must use a DVI-to-HDMI adapter to convert the video signal in the DVI format into a video signal in the HDMI format. The HDMI signal converted from the DVI signal does not have the audio data, and thus the television cannot play any sound and causes problems to such application. To solve the aforementioned audio signal problems, the present invention provides a method of using other audio signal interfaces to play audio signals outputted from a computer having a DVI interface only to a television having a HDMI interface only for the abovementioned application.

### SUMMARY OF THE INVENTION

Therefore, it is a primary objective of the present invention to provide an audio control system applied for a television and a method thereof to solve the aforementioned problem that sounds cannot be outputted due to incompatible interfaces.

To achieve the foregoing objective, the present invention provides an audio control system applied for a television, and the system comprises an analog audio signal input unit, an audio processor, a video processor, an HDMI interfacing unit and a determination unit. The analog audio signal input unit is used for receiving an analog audio signal, and the HDMI interfacing unit is used for receiving an HDMI signal and obtaining a digital video signal and a digital audio signal from the HDMI signal for the output. The video processor and audio processor are electrically connected to the HDMI interfacing unit, and the video processor is used for receiving and processing digital video signals. The determination unit is used for detecting an audio signal status of the HDMI interfacing unit and controlling the audio processor to receive digital audio signals or analog audio signals according to a detection result.

In addition, the present invention also provides an audio signal control method applied for television, where the television has an audio processor, and the method comprises the steps of: receiving an analog audio signal; receiving an HDMI signal; determining whether or not the HDMI signal has a digital audio signal; if the HDMI signal has a digital audio signal, then the audio processor will be controlled to use this digital audio signal as an input signal; if the HDMI signal does not have a digital audio signal, then the audio processor will be controlled to use this analog audio signal as an input signal.

In summation of the description above, users only need to prepare a DVI-to-HDMI adapter to connect a DVI audio/video output device with a HDMI television, and an audio signal line to connect an analog audio signal interface of the audio/video output device with the phone jack interface of the television, so that the system can automatically determine signals and allow the audio/video signals of the audio/video output device to be played on the television successfully, when the audio/video output device only comes with a DVI and an analog audio signal interface and the television only comes with a HDMI interface and a phone jack interface.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a block diagram of an audio control system of the present invention;

FIG. 2 is a schematic view of an audio control system in accordance with a preferred embodiment of the present invention; and

FIG. 3 is a flow chart of an audio control method in accordance with a preferred embodiment of the present invention.

### DETAILED DESCRIPTION OF THE PREFERRED EMBODIMENTS

In the following related figures, same reference numerals are used for the same elements of an audio control system applied for a television and a method thereof in accordance with a preferred embodiment of the present invention.

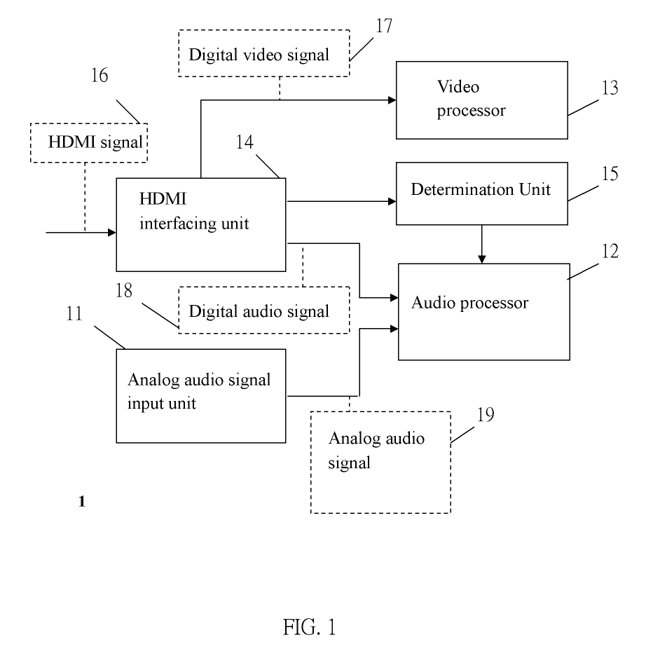

Referring to FIG. 1 for a block diagram of an audio control system applied for a television in accordance with the present invention, the audio control system 1 comprises an analog audio signal input unit 11, an audio processor 12, a video processor 13, an HDMI interfacing unit 14 and a determination unit 15. The analog audio signal input unit 11 receives an analog audio signal 19, and the HDMI interfacing unit 14 receives a HDMI signal 16 and obtains a digital video signal 17 and a digital audio signal 18 from the HDMI signal 16 for the output. The video processor 13 is electrically connected to the HDMI interfacing unit 14 for receiving a digital video signal 17 and processing a digital video signal 17 displayed on a display device of the television. The determination unit 15 detects an audio signal status of the HDMI interfacing unit 14 and controls the audio processor 12 to receive a digital audio signal 18 from the HDMI interfacing unit 14 or an analog audio signal 19 from the analog audio signal input unit 11 according to a detection result.

The analog audio signal input unit 11 is preferably a phone jack socket, and the HDMI interfacing unit 14 preferably includes an HDMI socket and an HDMI signal processing chip, and the determination unit 15 is preferably achieved by executing an arbitration program by a processor, or implementing a control chip.

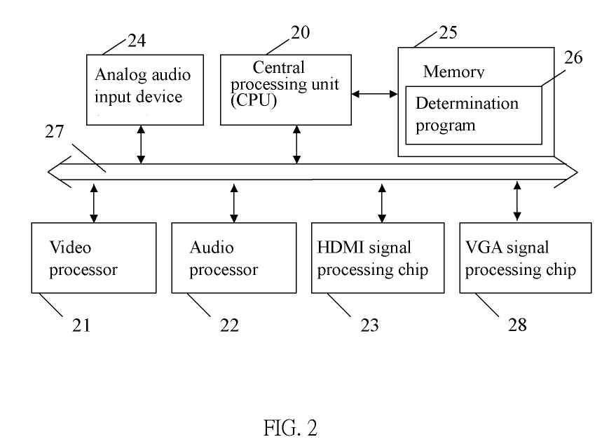

Referring to FIG. 2 for a schematic view of an audio control system applied for a television in accordance with a preferred embodiment of the present invention, the television comprises a CPU chip 20, a video processing chip 21, an audio processing chip 22, an HDMI signal processing chip 23, an analog audio signal input device 24, a memory 25, a VGA signal processing chip 28 and a bus 27. The CPU chip 20, video processing chip 21, audio processing chip 22, HDMI signal processing chip 23, analog audio signal input device 24 and VGA signal processing chip 28 are electrically connected to the bus 27 for transmitting control signals among the aforementioned components. In general, the VGA signal processing chip 28 and analog audio signal input device 24 are set as predetermined audio/video input devices of the television, and thus the video processing chip 21 and audio processing chip 22 are provided for receiving an analog video signal from the VGA signal processing chip 28 and an analog audio signal from the analog audio signal input device 24 as an input signal for the processing respectively

If a user wants to input an HDMI signal to a television for the playback, the user needs to set the audio/video input interface of the television to the HDMI through an operating menu of the television, and the CPU 20 sends a control signal through the bus 27 for controlling the video processing chip 21 and audio processing chip 22 to receive a digital video signal and a digital audio signal of the HDMI signal processing chip 23 as an input signal for the processing respectively In addition, the CPU 20 also executes an arbitration program stored in the memory 25 for detecting whether or not the signal processed by the HDMI signal processing chip 23 has an audio signal component. If the signal has an audio signal component, it shows that the user has inputted an HDMI signal, and the audio processing chip 22 will continue receiving a digital audio signal from the HDMI signal processing chip 23.

On the other hand, if a user uses a DVI-to-HDMI adapter to convert a DVI signal into an HDMI signal that is inputted to a television, the converted HDMI signal will have no audio signal component since the DVI signal only contains a digital video signal, and the CPU 20 controls the audio processing chip 22 through the bus 27 to receive an analog audio signal from the analog audio signal input device 24 for its processing and playback. Most of the present electronic devices with the audio/video input/output functions such as televisions or computers are equipped with an analog audio/video interface, and the digital audio/video interface usually is incorporated into a high-end electronic device. If a user's notebook computer only has a DVI interface and an analog audio interface and the television only has an HDMI and a phone jack interface, users simply need to prepare a DVI-to-HDMI adapter to connect the DVI of the audio/video output device with the HDMI interface of the television, and an audio signal line to connect the analog video interface of the audio/video output device with the phone jack interface of the television, if the television is equipped with an audio control system in accordance with the present invention, and the audio control system of the invention can then determine the signals automatically and allow the audio/video signals outputted by the audio/video output device to be played on the television successfully, so as to solve the problem of the inability to output sounds from the television.

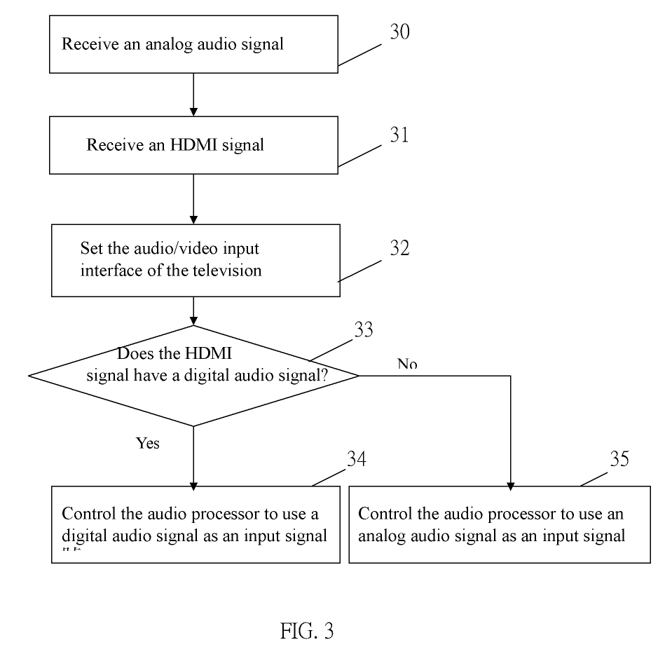

Referring to FIG. 3 for a flow chart of an audio control method in accordance with a preferred embodiment of the present invention, the method corresponding to the audio control system 1 as illustrated in FIG. 1 comprises the steps of:

Step 30: using an analog audio signal input unit 11 to receive an analog audio signal, and sending the analog audio signal to an audio processor 12;

Step 31: using an HDMI interfacing unit 14 to receive an HDMI signal, and obtain a digital video signal 17 and a digital audio signal 18 from an HDMI signal 16 and send them to a video processor 13 and an audio processor 12;

Step 32: setting the audio/video input interface of the television to HDMI through an operating menu of the television;

Step 33: using a determination unit 15 to detect whether or not the HDMI signal has a digital audio signal; if yes, then go to Step 34, or else go to Step 35;

Step 34: controlling the audio processor 12 to use a digital audio signal from the HDMI interfacing unit 14 as an input signal for the processing, and controlling the video processor 13 to use a digital video signal from the HDMI interfacing unit 14 as an input signal for the processing;

Step 35: controlling the audio processor 12 to use an analog audio signal from the analog audio signal input unit 11 as an input signal for the processing, and controlling the video processor 13 to use a digital video signal from the HDMI interfacing unit 14 as an input signal for the processing.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio control system applied for a television, comprising:
an analog audio signal input unit, for receiving an analog audio signal;
a high definition multimedia interface (HDMI) interfacing unit, for receiving an HDMI signal, and retrieving and outputting a digital video signal and a digital audio signal from said HDMI signal;
a video processor, electrically connected to said HDMI interfacing unit, for receiving and processing said digital video signal;
an audio processor, electrically connected to said HDMI interfacing unit; and
a determination unit, for detecting the audio signal status of said HDMI interfacing unit, and controlling said audio processor to receive said digital audio signal or controlling said analog audio signal received by or sent from said analog audio signal input unit according to a detection result.

2. The audio control system of claim 1, wherein if said detection result shows that said HDMI signal does not include an audio component, then said determination unit will control said audio processor to receive said analog audio signal.

3. The audio control system of claim 1, wherein if said detection result shows that said HDMI signal includes an audio component, then said determination unit will control said audio processor to receive said digital audio signal.

4. The audio control system of claim 1, wherein said determination unit is implemented by using a processor to execute an arbitration program.

5. The audio control system of claim 1, wherein said analog audio signal input unit is a phone jack socket.

6. The audio control system of claim 1, wherein said HDMI interfacing unit includes an HDMI socket and an HDMI signal processing chip.

7. An audio control method applied for a television, and said television having an audio processor, and said method comprising the steps of:
receiving an analog audio signal;
receiving an HDMI signal;
determining whether or not said HDMI signal has a digital audio signal;
controlling said audio processor to use said digital audio signal as an input signal, if said HDMI signal has a digital audio signal; and
controlling said audio processor to use said analog audio signal as an input signal, if said HDMI signal does not have said digital audio signal.

8. The audio control method of claim 7, wherein said step of receiving an analog audio signal is achieved by a phone jack socket.

9. The audio control method of claim 7, wherein said step of determining whether or not said HDMI signal has a digital audio signal is achieved by using a processor to execute an arbitration program.
